(19) United States
(12) Patent Application Publication
(10) Pub. No.: US 2019/0179599 A1
(43) Pub. Date: Jun. 13, 2019

(54) INFORMATION PROCESSING METHOD, INFORMATION PROCESSOR, AND AUDIO DEVICE

(71) Applicant: YAMAHA CORPORATION, Hamamatsu-shi (JP)

(72) Inventor: Masato ESASHI, Halstenbek (DE)

(21) Appl. No.: 16/205,465

(22) Filed: Nov. 30, 2018

(30) Foreign Application Priority Data
Dec. 11, 2017 (JP) 2017-236789

(51) Int. Cl. G06F 3/16; G06F 3/0481; G06F 3/0484

(52) U.S. Cl. CPC G06F 3/165; G06F 3/0484; G06F 3/0481

(57) ABSTRACT

An information processing method displays a track editing screen to create multitrack content, on a display of an information processor, receives selection of one track among tracks displayed on the track editing screen, displays a management screen to perform signal processing of a selected track, on the track editing screen, and displays a management screen of an external audio device, on the management screen to perform the signal processing.

### CROSS REFERENCE TO RELATED APPLICATIONS

This Nonprovisional application claims priority under 35 U.S.C. § 119(a) on Patent Application No. 2017-236789 filed in Japan on Dec. 11, 2017 the entire contents of which are hereby incorporated by reference.

### BACKGROUND OF THE INVENTION

### 1. Field of the Invention

A preferred embodiment of the present invention relates to an information processing method, an information processor, and audio device that are configured to perform tasks such as settings of an audio interface device.

### 2. Description of the Related Art

Conventionally, a configuration in which a setting screen of an audio interface device (hereinafter referred to as an IO device) is displayed on the mixer screen of a Digital Audio Workstation (hereinafter referred to as DAW) has been known.

However, a DAW user not only performs mastering using the mixer screen, but also uses a screen to perform work on each individual track in a music composition stage in many cases.

When operating each individual track, the user has had a problem that the relationship between a track during operation and an IO device is unclear. For example, it is difficult to grasp whether or not an audio signal to be inputted to the track during operation is an audio signal to which effect processing has been applied in the IO device.

### SUMMARY OF THE INVENTION

In view of the foregoing, a preferred embodiment of the present invention is directed to provide an information processing method, an information processor, and audio device that are able to easily grasp the relationship between each individual track and an IO device.

An information processing method according to a preferred embodiment of the present invention displays a track editing screen to create multitrack content, on a display of an information processor, receives selection of one track among tracks displayed on the track editing screen, displays a management screen to perform signal processing of a selected track, on the track editing screen, and displays a management screen of an external audio device, on the management screen to perform the signal processing.

According to a preferred embodiment of the present invention, it is possible to easily grasp the relationship between each individual track and an IO device.

The above and other elements, features, characteristics, and advantages of the present invention will become more apparent from the following detailed description of the preferred embodiments with reference to the attached drawings.

### BRIEF DESCRIPTION OF THE DRAWINGS

FIG. 1 is a block diagram showing a configuration of an audio system 1.

FIG. 2 is a block diagram showing a configuration of a PC 11.

FIG. 3 is a block diagram showing a configuration of an IO device 12.

FIG. 4 is an example of a GUI displayed on a display 101 of the PC 11.

FIG. 5 is a view showing details of a management screen 70.

FIG. 6 is a view showing details of a management screen 70.

FIG. 7 is a view showing details of a management screen 70.

FIG. 8A is a view showing details of a management screen 70.

FIG. 8B is a view showing details of a management screen 70.

FIG. 9A is a view showing an example of a port list screen.

FIG. 9B is a view showing an example of a port list screen.

FIG. 10 is a flow chart showing operation of a DAW.

FIG. 11 is a flowchart showing operation when hardware monitoring is turned ON/OFF.

FIG. 12 is a flowchart showing operation when effect processing in the IO device 12 is turned ON/OFF.

FIG. 13 is a flow chart showing operation of each device in a case in which, in the IO device 12, a user changes settings and a state has changed.

FIG. 14 is a flow chart showing operation of each device in a case in which, in the DAW, a user changes settings and a state has changed.

FIG. 15 is a flow chart showing operation of an Editor.

FIG. 16 is a view showing an example of a port list screen.

### DETAILED DESCRIPTION OF THE PREFERRED EMBODIMENTS

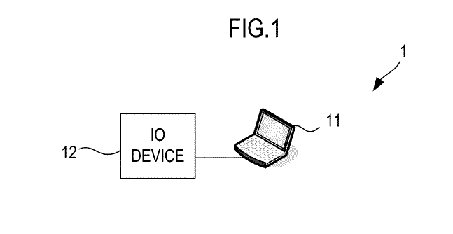

FIG. 1 is a block diagram showing a configuration of an audio system 1. The audio system 1 includes a PC 11 being an example of an information processor, and an IO device 12 being an example of an audio device. The PC 11 and the IO device 12 are connected to each other through a communication interface such as a USB (Universal Serial Bus), IEEE 1394, a LAN (Local Area Network), or a MIDI (Musical Instrument Digital Interface).

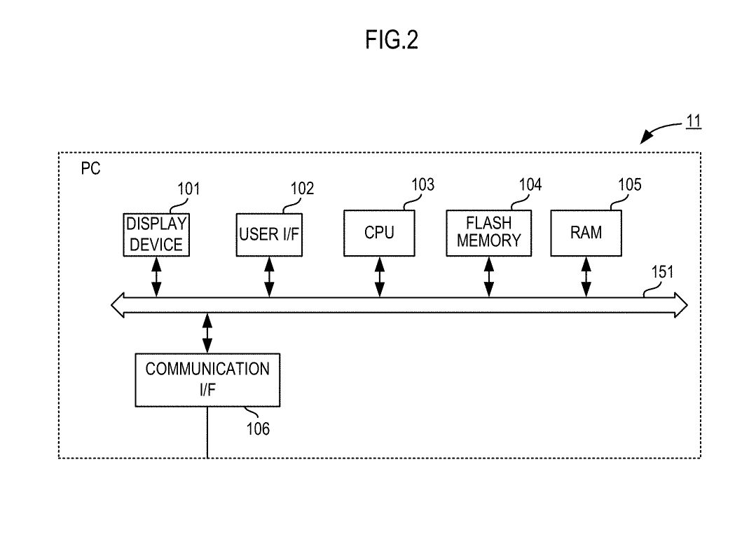

FIG. 2 is a block diagram showing a configuration of a PC 11. The PC 11 includes components such as a display 101, a user interface (I/F) 102, a CPU 103, a flash memory 104, a RAM 105, and a communication interface (I/F) 106. The components are connected to a bus 151.

The display 101 may include an LCD (Liquid Crystal Display), for example, and displays various types of information. The user I/F 102 includes a mouse or a keyboard, and receives operation of a user. The user I/F 102, together with the display 101, configures a GUI (Graphical User Interface).

The CPU 103 corresponds to a controller. The CPU 103 reads out a program stored in the flash memory 104 being a storage medium to the RAM 105, and achieves a predetermined function. For example, the CPU 103 displays an image of an operation portion to receive operation of a user on the display 101, and, through the user I/F 102, receives operation such as selection operation to the image of the operation portion to provide a GUI. In addition, the CPU 103 reads out a program (hereinafter referred to as a DAW) to edit music, and a program (hereinafter referred to as Editor) to manage the hardware of the IO device 12 from the flash memory 104, and provides a GUI related to these programs.

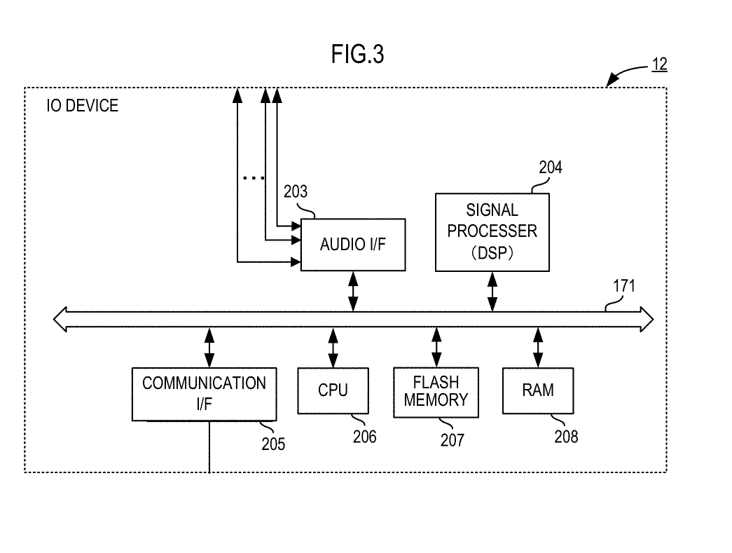

As shown in FIG. 3, the IO device 12 includes components such as an audio interface (I/F) 203, a signal processor 204, a communication interface (I/F) 205, a CPU 206, a flash memory 207, and a RAM 208.

The components are connected through a bus 171. In addition, the audio I/F 203 and the signal processor 204 are also connected to a waveform bus configured to transmit a digital audio signal.

The CPU 206 is a controller to control operation of the IO device 12. The CPU 206 performs various types of operation by reading out a predetermined program stored in the flash memory 207 being a storage medium to the RAM 208 and executing the program. For example, the CPU 206, based on various types of commands that have been received from the PC 11 through the communication I/F 205, executes input and output of an audio signal in the audio I/F 203, mixing processing in the signal processor 204, control of effect processing, a change in setting value of a parameter, and the like.

The signal processor 204 is configured by a plurality of DSPs to perform various types of signal processing such as mixing processing or effect processing. The signal processor 204 applies effect processing such as compressing processing of sound pressure by a compressor, provision processing of a reverberant sound and reflective sound by reverb, or equalizing, to an audio signal to be inputted through an input terminal in the audio I/F 203. The signal processor 204 outputs the audio signal to which the signal processing has been applied, through an output terminal in the audio I/F 203. In addition, the signal processor 204 outputs the audio signal to which the signal processing has been applied, to the PC 11 through the communication I/F 205.

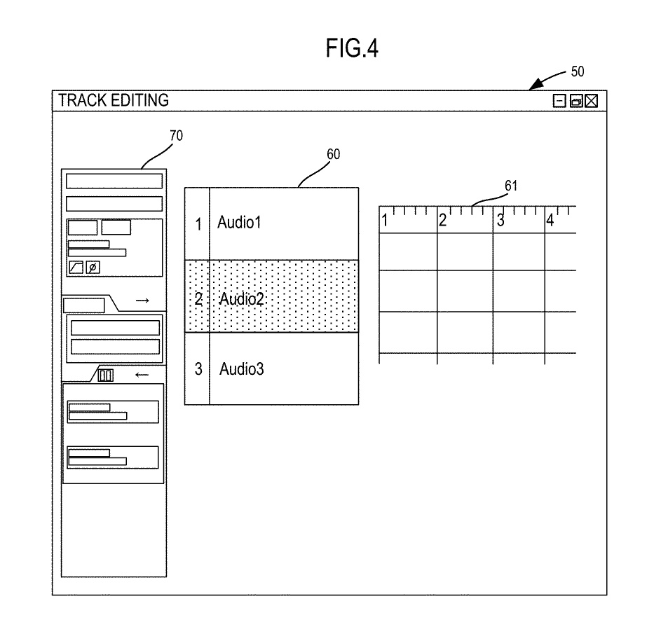

FIG. 4 is an example of a GUI displayed on a display 101 of the PC 11. The GUI shown in FIG. 4 is an example of a track edit screen 50 to create multitrack content in a DAW. The CPU 103 displays a track list 60, a time line 61, and a management screen 70 on the track edit screen 50.

The track list 60 displays one or a plurality of tracks. A user selects any one of the tracks in the track list 60. When the user selects a track, a time-axis waveform of a selected track and the like are displayed on the time line 61. As described above, the user can record or edit the selected track.

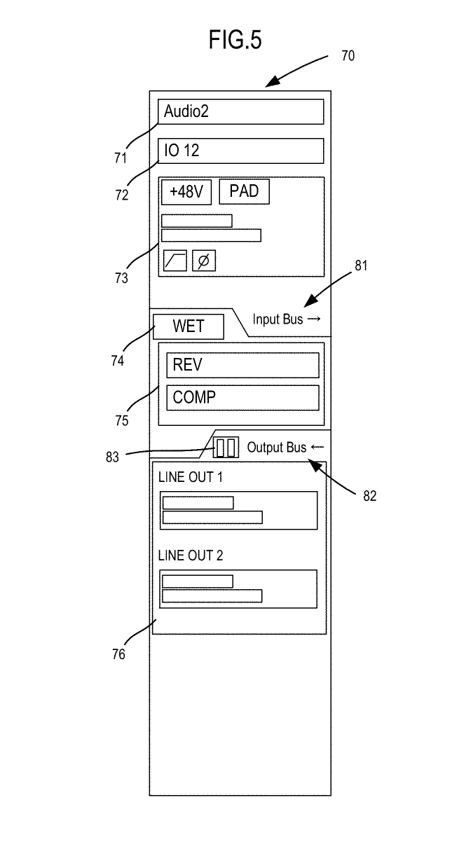

In addition, when the user selects a track, the CPU 103 displays the management screen 70 to perform signal processing of the selected track. FIG. 5 is a view showing details of the management screen 70.

The management screen 70 has a selected track name display field 71, a corresponding IO device name display field 72, an input display field 73, a WET display icon 74, an effect display field 75, an output display field 76, an input bus display 81, an output bus display 82, and an output bus meter 83.

The name of the track being selected at present is displayed on the selected track name display field 71. The name of the IO device 12 being connected is displayed on the corresponding IO device name display field 72.

The input display field 73 corresponds to the management screen of signal processing on an input side in the IO device 12. In this example, the input display field 73 includes a phantom power source, an attenuator, a low cut filter, and a mute ON/OFF button. In addition, the input display field 73 includes a meter corresponding to a signal level.

The WET display icon 74 and the effect display field 75 show whether or not various types of effect processing in the IO device 12 is performed. In this example, reverb (REV) and a compressor (COMP) are displayed on the effect display field 75. As a matter of course, the effect processing being displayed in this example is an example, and other various types of effect processing are able to be performed.

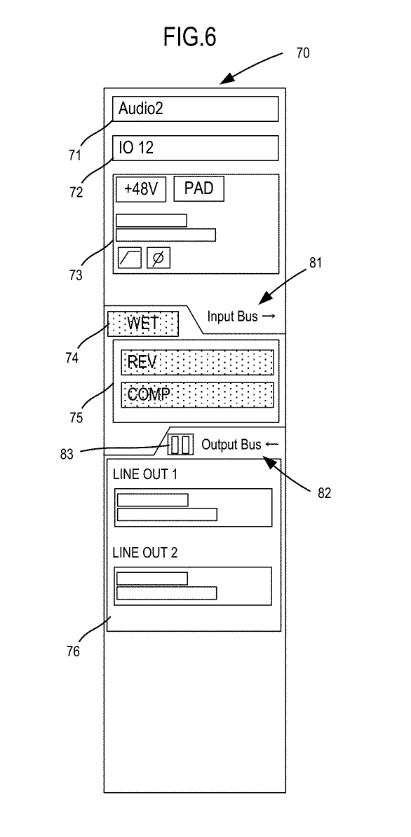

When a user sets effect processing in the IO device 12 to be enabled, as shown in FIG. 6, the WET display icon 74 is highlighted. In addition, each type of effect processing of the effect display field 75 is also highlighted. The user can switch enabling and disabling of the effect processing in the IO device 12, for example, when clicking the WET display icon 74. As a result, the user can easily grasp a first state in which the effect processing in the IO device 12 is performed, and a second state in which the effect processing in the IO device 12 is not performed.

In addition, in this example, the input bus display 81 is displayed above the WET display icon 74 and the effect display field 75, and the output bus display 82 is displayed below the WET display icon 74 and the effect display field 75.

The input bus display 81 shows an input position at which an audio signal is input to the PC 11. The output bus display 82 shows an output position at which an audio signal is output from the PC 11. Each display field displayed on the management screen 70 is disposed from the top to the bottom along the flow of an audio signal. In other words, the input display field 73 is displayed in the top part, the WET display icon 74 and the effect display field 75 are displayed in the middle part, and the output display field 76 is displayed in the bottom part. Furthermore, the input bus display 81 is located between the input display field 73, and the WET display icon 74 and the output display field 76. Accordingly, the user can easily grasp that the audio signal to which signal processing of content displayed in the input display field 73 has been applied is being inputted to the track being worked on in the PC 11. In addition, the output bus display 82 is located between the WET display icon 74 and the effect display field 75, and the output display field 76. Accordingly, the user can easily grasp that the audio signal is being outputted to the output side of the IO device 12 after signal processing shown by the track being worked on in the PC 11 is performed.

In addition, the output bus meter 83 is displayed in the vicinity of the output display field 76. The output bus meter 83 changes a display corresponding to the level of an audio signal. Accordingly, the user can easily grasp whether or not the audio signal is being outputted from the PC 11 to the IO device 12.

As described above, the user can easily grasp the relationship between the track being worked on and the IO device 12. In addition, the user can intuitively grasp the flow of the audio signal.

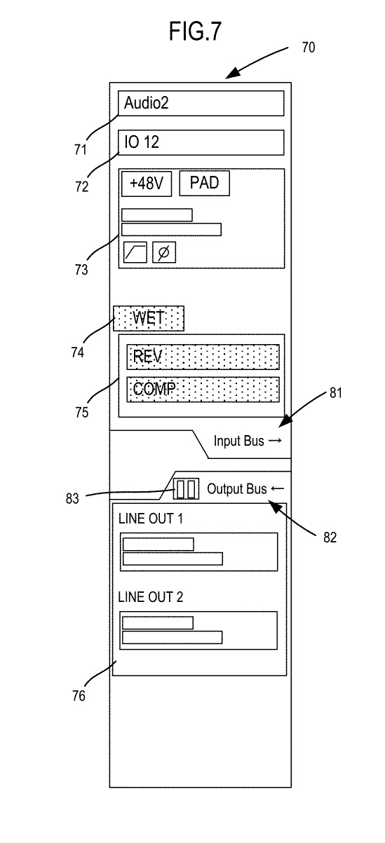

In addition, the user can easily grasp that the audio signal to be inputted to and outputted from the PC 11 changes in a case in which the position of the input bus display 81 or the output bus display 82 changes. For example, the audio signal is assumed to have been inputted to the track being worked on in the PC 11 after signal processing of the content displayed in the effect display field 75 in the IO device 12 is performed. In such a case, as shown in FIG. 7, the position of the input bus display 81 is displayed below the WET display icon 74 and the effect display field 75. Accordingly, the user easily grasp that the audio signal to be inputted to and outputted from the PC 11 is an audio signal to which effect processing has been applied in the IO device 12.

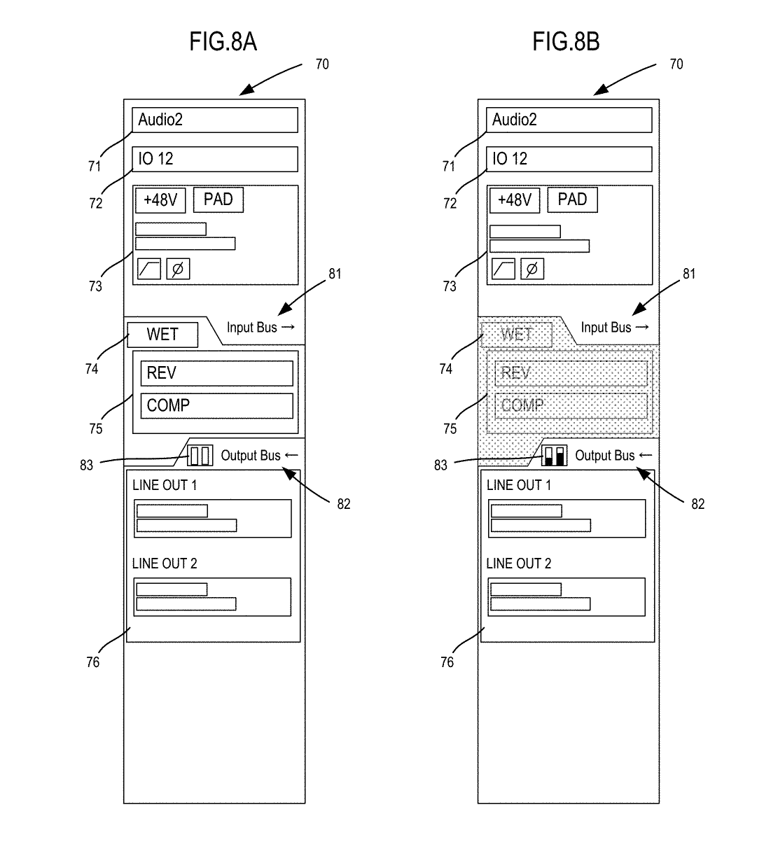

Subsequently, FIG. 8A and FIG. 8B are views showing an example in which display in a third state (hereinafter referred to as hardware monitoring) in which an audio signal that has been inputted to the IO device 12 is outputted from the IO device 12 without being inputted to the PC 11 and display in a fourth state (hereinafter referred to as software monitoring) in which an input audio signal is outputted through the PC 11 are changed. FIG. 8A is a management screen 70 in a case in which the hardware monitoring is turned on, and FIG. 8B is a management screen 70 in a case in which the software monitoring is turned on (in other words, the hardware monitoring is turned off).

A user may connect a sound source to an input terminal of the IO device 12 and may also connect a headphone or the like to an output terminal of the IO device 12, and may play music while listening to the sound of the sound source and may make a recording. In such a case, a certain amount of delay occurs in the software monitoring in which an input audio signal is outputted through the PC 11. Therefore, the user may make a recording by the hardware monitoring in which an audio signal that has been inputted to the IO device 12 is outputted from the IO device 12 without being inputted to the PC 11.

In this example, as shown in FIG. 8A and FIG. 8B, in a case in which the hardware monitoring is turned off, a portion from the input bus display 81 to the output bus display 82 is grayed out. As a result, to the user, the flow of the audio signal appears to have been blocked in the IO device 12. Therefore, the user can intuitively recognize that the input audio signal is to be outputted through the PC 11.

In addition, in a case in which the hardware monitoring is turned off, the display of the output bus meter 83 changes corresponding to the level of an audio signal. Therefore, the user can recognize that the input audio signal is to be outputted through the PC 11.

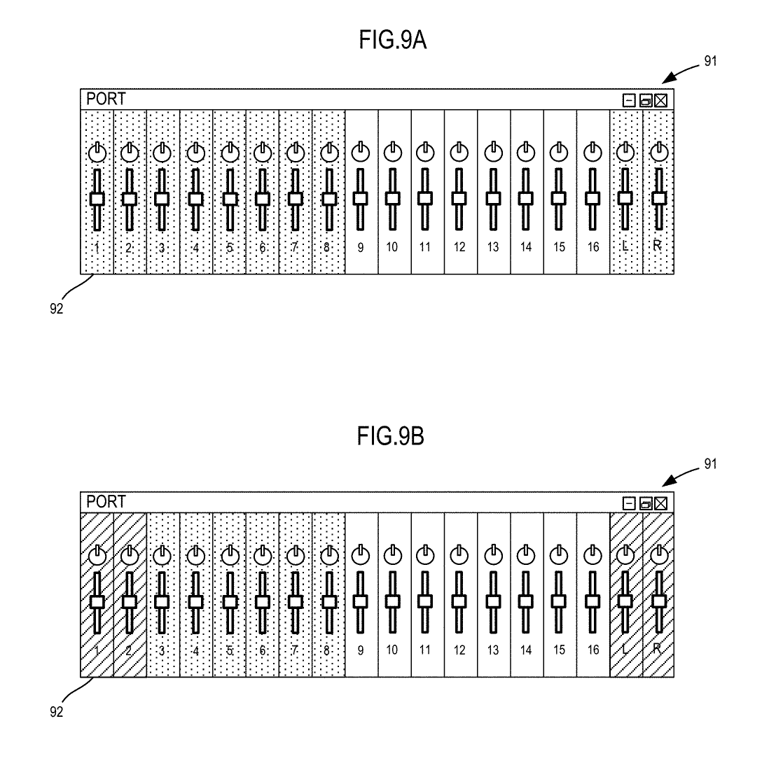

Subsequently, FIG. 9A and FIG. 9B is a view showing an example of a port list screen. The port list screen 91 is a screen to be displayed by an Editor to manage the IO device 12.

On the port list screen 91, channel strips corresponding to the ports of a plurality of pieces of hardware mounted in the IO device 12 are displayed side by side in the lateral direction. The user can manage the settings of each port of the IO device 12 by operating the channel strips on the port list screen 91.

In the present preferred embodiment, as shown in FIG. 9A, the CPU 103 changes a display mode between a port assigned to the DAW of the PC 11 and ports other than the port. For example, in the example of FIG. 9A, a port 1 to a port 8 and ports L and R on an output side are assigned to the DAW. Accordingly, the CPU 103 highlights the port 1 to the port 8 and the ports L and R on the output side.

In addition, as shown in FIG. 9B, the CPU 103 changes a display mode between a port assigned to a track selected in the DAW and ports other than the port. In the example of FIG. 9B, the ports 1 and 2 and the ports L and R on the output side are assigned to a bus connected to a selected track. Accordingly, the CPU 103 displays the ports 1 and 2 and the ports L and R on the output side in different color (in red, for example). In addition, tracks including a track being currently recorded, a track set to be solo (a state in which other tracks are muted and only a specified track is outputted), a track set to be SoloDefeat (a state in which a track is outputted even when other tracks set to be solo are present), the track set to be mute, a track set to be in the hardware monitoring or the software monitoring may be displayed in respective different display modes.

As a matter of course, the display mode is not limited to these examples. For example, only the color of a fader may be changed or the display of a port that is not used by the DAW may be cleared.

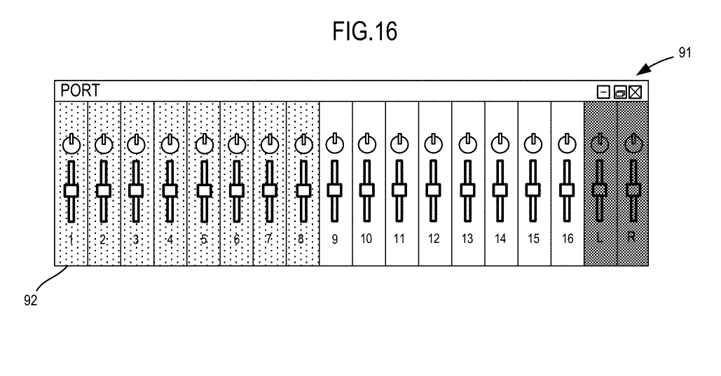

It is to be noted that, although the user can change the setting of a port on the port list screen 91, in a case in which the setting of the DAW is also changed if the setting of a port is changed, the CPU 103, in a case in which parameters or tracks that do not correspond one on one are present in the setting of the port and the setting of the DAW, may preferably set the setting operation of a port so as not to be received (the operation is disabled) or, as shown in FIG. 16, may preferably make a port look inoperable by operation such as graying out. In other words, the CPU 103, in a case in which a plurality of tracks or a plurality of signal processing parameters correspond to a certain port, prohibits operation to the port.

For example, in a case in which a volume parameter of a track A, a volume parameter of a track B, and a volume parameter of the ports L and R on the output side are present, the CPU 103, when changing any of the volume parameter of the track A and the volume parameter of the track B, is able to change the volume parameters of the ports L and R on the output side by calculating from the volume parameter of the track A or the volume parameter of the track B. However, conversely, in a case in which the volume parameters of the ports L and R on the output side are changed, which of the volume parameter of the track A or the volume parameter of the track B should be changed is not able to be determined. As described above, in a case in which parameters or tracks that do not correspond one on one are present in the setting of the port and the setting of the DAW, the CPU 103 may preferably set the setting operation of a port so as not to be received or may preferably make a port look inoperable.

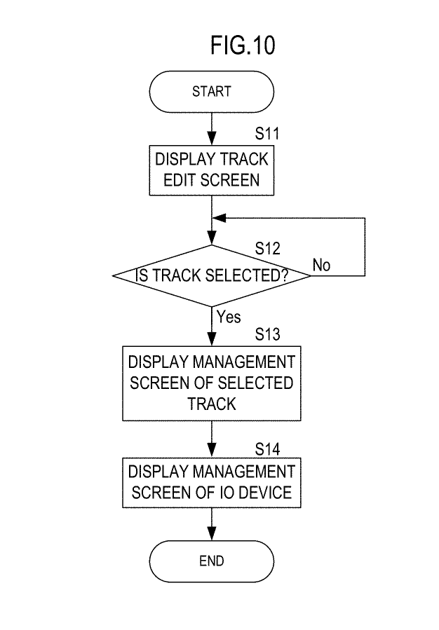

FIG. 10 is a flow chart showing the operation of the DAW. The CPU 103, when a user starts the program of the DAW and instructs a display of a track edit screen, performs the operation of this flow chart.

First, the CPU 103 displays a track edit screen 50 on a display 101 (S11). Subsequently, the CPU 103 determines whether or not a specific track has been selected (S12). The CPU 103 repeats determination of the S12 when a track is not selected (S12: No). The CPU 103, when a track is selected (S12: Yes), displays a management screen 70 of the selected track (S13). Then, the CPU 103 displays a management screen of an IO device 12 on the management screen 70 (S14). The management screen of the IO device 12 includes the input display field 73, the WET display icon 74, the effect display field 75, the output display field 76, the input bus display 81, the output bus display 82, and the output bus meter 83.

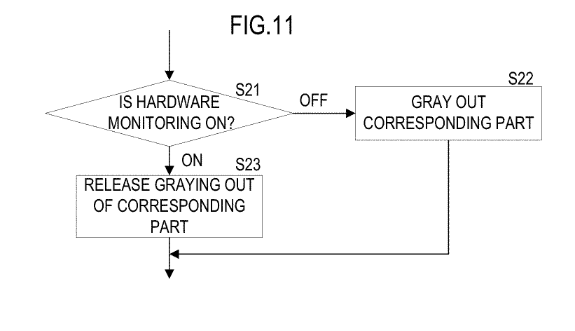

FIG. 11 is a flowchart showing operation when the hardware monitoring is turned ON/OFF. The CPU 103 determines whether a user turns the hardware monitoring on or off (S21). The user instructs to turn the hardware monitoring ON/OFF on the DAW. When the user instructs to turn the hardware monitoring off, the CPU 103 grays out a corresponding part (S22). For example, the CPU 103, as shown in FIG. 8B, grays out a part from the input bus display 81 to the output bus display 82. In addition, when a user instructs to turn the hardware monitoring ON, the CPU 103 undoes a grayed out part, as shown in FIG. 8A (S23).

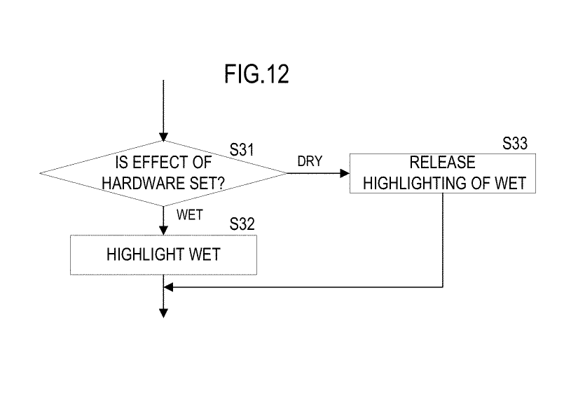

FIG. 12 is a flowchart showing operation when effect processing in the IO device 12 is turned ON/OFF. The CPU 103 determines whether or not the user sets effect processing to be enabled by a DSP 204 in the IO device 12 (S31). In a case in which a user enables effect processing (in a case of setting to WET), as shown in FIG. 6, the WET display icon 74 is highlighted (S32). In addition, each type of effect processing of the effect display field 75 is also highlighted. The user can switch enabling and disabling of the effect processing in the IO device 12, for example, when clicking the WET display icon 74. On the other hand, in a case in which a user disables effect processing (in a case of setting to DRY), the highlighting of the WET display icon 74 is released (S33).

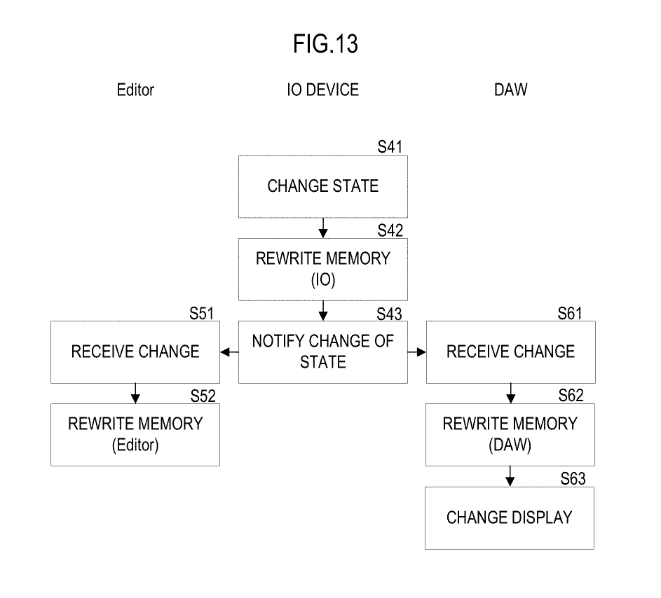

FIG. 13 is a flow chart showing the operation of each device in a case in which a user changes settings and a state has changed in the IO device 12. As described above, the CPU 103 of the PC 11 reads out each of the DAW and the Editor from the flash memory 104 and executes the DAW and the Editor. At this time, a work memory for the DAW and a work memory for the Editor are separately secured in the RAM 105.

In a case in which the state in the IO device 12 changes (S41), the CPU 206 of the IO device 12 first rewrites the content of the work memory secured in the RAM 208 of the self device (S42). The change of state includes a change of a port, ON/OFF of hardware monitoring, or ON/OFF of effect processing, for example. The CPU 206, after rewriting the content of the work memory, transmits information that indicates the rewritten content to the PC 11 through the communication I/F 205. As a result, the IO device 12 makes a notification that the state of the self device is changed (S43).

The Editor of the PC 11 receives the notification through the communication interface 106, and receives the change of state of the IO device 12 (S51). In addition, the Editor rewrites the content of the work memory for the Editor (S52). Then, in the PC 11 of the present preferred embodiment of the present invention, in addition to the Editor, the DAW also receives the notification through the communication interface 106, and receives the change of state of the IO device 12 (S61). The DAW rewrites the content of the work memory for the DAW (S62), and also changes the display of the management screen 70 (S63). For example, when ON/OFF of effect processing is switched, the DAW highlights the effect processing of the WET display icon 74 and the effect display field 75.

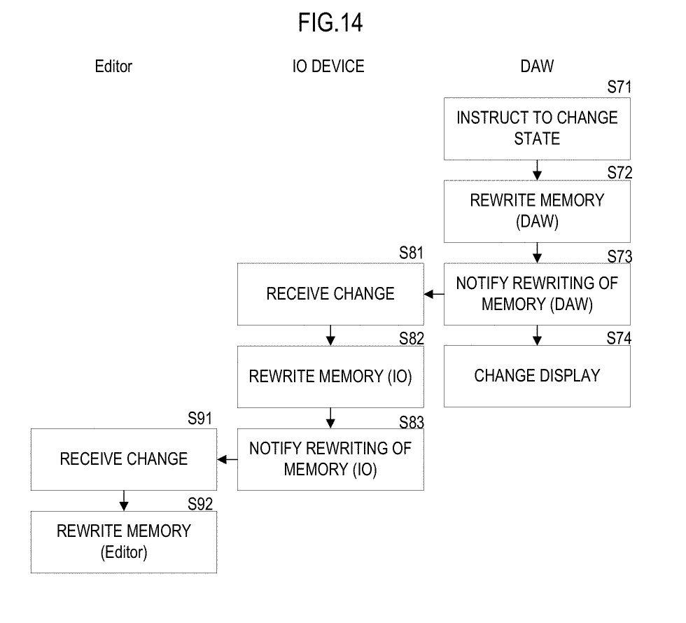

FIG. 14 is a flow chart showing operation of each device in a case in which, in the DAW, a user changes settings and a state has changed. When a user instructs to change the state of the IO device 12 through a GUI (S71), the DAW rewrites the content of the work memory for the DAW (S72), and sends information that indicates the rewritten content to the IO device 12 through the communication interface 106 (S73). In addition, the DAW changes the display of the management screen 70 (S74).

The IO device 12 receives the change of state from the DAWthrough the communication I/F 205 (S81), and rewrites the content of the work memory of the self device (S82). As a result, the state of the IO device 12 changes. For example, when a user, in the DAW, changes the setting of a port to be assigned, the IO device 12 changes assignment from each port to the DAW.

Further, the IO device 12 sends information that indicates the rewritten content to the Editor of the PC 11 (S83). The Editor of the PC 11 receives the notification through the communication interface 106, and receives the change of state of the IO device 12 (S91). In addition, the Editor rewrites the content of the work memory for the Editor (S92).

In this manner, even in a case in which the setting of the IO device 12 is changed in the DAW, the content is also notified to the IO device 12 and the Editor, and the content of the memory in all the devices is rewritten.

In other words, the IO device 12 has the following technical idea.

An audio device includes an input and output interface of an audio signal, a communication interface configured to be connected to an information processor, a memory configured to store information that indicates the state of the self device, and a controller configured to rewrite the information of the memory, send the information that indicates the rewritten content, to the information processor through the communication interface, makes the information of the memory of the information processor rewritten, and change the display of an track edit screen to create multitrack content in the information processor.

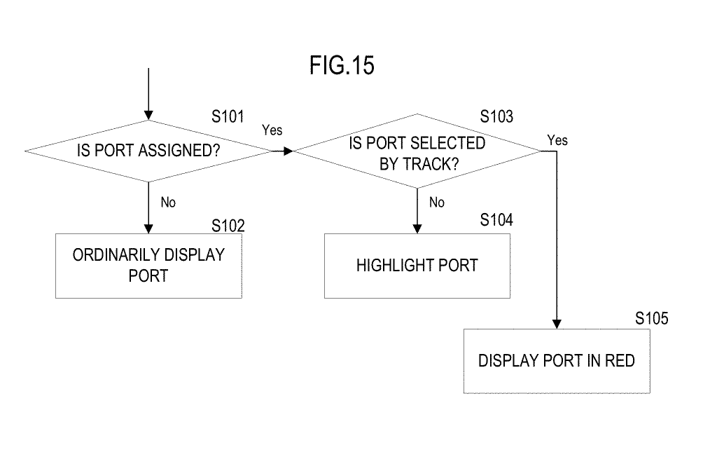

It is to be noted that, in S71, in a case in which a user instructs to change a port or change a track, the Editor performs operation shown in FIG. 15.

The Editor performs operation shown in the flow chart of FIG. 15 for each port. First, the Editor determines whether or not the current port is assigned to the DAW (S101). When the current port is not assigned to the DAW (S101: No), the Editor makes the port ordinarily displayed (S102). For example, the Editor does not highlight or color a port that is not assigned to the DAW, as shown in the port 9 to the port 16 in FIG. 9A and FIG. 9B.

The Editor, in a case in which the current port is assigned to the DAW (S101: Yes), further determines whether or not the port is used by the track being currently selected in the DAW (S103). In a case in which the port is not used by the track being currently selected (S103: No), the Editor makes the display of the port highlighted (S104). For example, the Editor perform highlighting as shown in the port 1 to the port 8 and the ports L and R on the output side of FIG. 9A and FIG. 9B.

On the other hand, the Editor, in a case in which the current port is used by the track being selected (S103: Yes), makes the port differently displayed, that is, displayed in red, for example (S105).

As a result, in S71, in a case in which a user instructs to change a port or change a track, while the IO device 12 changes the setting, the Editor also changes the display of the port list screen 91.

Lastly, the foregoing preferred embodiments are illustrative in all points and should not be construed to limit the present invention. The scope of the present invention is defined not by the foregoing preferred embodiment but by the following claims. Further, the scope of the present invention is intended to include all modifications within the scopes of the claims and within the meanings and scopes of equivalents.

What is claimed is:

1. An information processing method comprising:
displaying a track editing screen to create multitrack content, on a display of an information processor;
receiving selection of one track among tracks displayed on the track editing screen;
displaying a management screen to perform signal processing of a selected track, on the track editing screen; and
displaying a management screen of an external audio device, on the management screen to perform signal the processing.

2. The information processing method according to claim 1, wherein the management screen of the external audio device is a screen that shows a flow from an input to an output of an audio signal.

3. The information processing method according to claim 1, further comprising changing, on the management screen of the external audio device, a display between a first state in which signal processing is performed in the external audio device and a second state in which signal processing is not performed in the external audio device.

4. The information processing method according to claim 1, further comprising changing, on the management screen of the external audio device, a display between a third state in which an inputted audio signal that has been inputted to the external audio device is outputted without being inputted to the information processor and a fourth state in which the inputted audio signal is outputted through the information processor.

5. The information processing method according to claim 1, further comprising displaying, on the management screen of the external audio device, a position at which an inputted audio signal that has been inputted to the external audio device is inputted to the information processor and a position at which the inputted audio signal is outputted from the information processor.

6. The information processing method according to claim 1, further comprising:
displaying a list screen on which ports that are used in the external audio device are listed; and
changing, among the ports, a display mode between a port to be assigned to the information processor and remaining ports other than the port.

7. The information processing method according to claim 6, further comprising changing, on the list screen, a display mode between a specific port and remaining ports other than the specific port.

8. The information processing method according to claim 7, wherein the specific port is a port to be assigned to the selected track.

9. The information processing method according to claim 8, further comprising setting a port among ports to be assigned to the information processor so as not to receive operation, the port being assigned to a plurality of tracks or a plurality of parameters of the signal processing.

10. The information processing method according to claim 8, further comprising changing, on the list screen, a display mode of a port among ports to be assigned to the information processor, the port being assigned to a plurality of tracks or a plurality of parameters of the signal processing.

11. An information processor comprising:
a display; and
a controller configured to:
display a track editing screen to create multitrack content, on the display;
receive selection of one track among tracks displayed on the track editing screen;
display a management screen to perform signal processing of a selected track, on the track editing screen; and
display a management screen of an external audio device, on the management screen to perform the signal processing.

12. The information processor according to claim 11, wherein the management screen of the external audio device is a screen that shows a flow from an input to an output of an audio signal.

13. The information processor according to claim 11, wherein the controller changes, on the management screen of the external audio device, a display between a first state in which signal processing is performed in the external audio device and a second state in which signal processing is not performed in the external audio device.

14. The information processor according to claim 11, wherein the controller changes, on the management screen of the external audio device, a display between a third state in which an inputted audio signal that has been inputted to the external audio device is outputted without being inputted to the information processor and a fourth state in which the inputted audio signal is outputted through the information processor.

15. The information processor according to claim 11, wherein the controller displays, on the management screen of the external audio device, a position at which an inputted audio signal that has been inputted to the external audio device is inputted to the information processor and a position at which the inputted audio signal is outputted from the information processor.

16. The information processor according to claim 11, wherein the controller displays a list screen on which ports that are used in the external audio device are listed; and changes, among the ports, a display mode between a port to be assigned to the information processor and remaining ports other than the port.

17. The information processor according to claim 16, wherein the controller changes, on the list screen, a display mode between a specific port and remaining ports other than the specific port.

18. The information processor according to claim 17, wherein the specific port is a port to be assigned to the selected track.

19. The information processor according to claim 18, wherein the controller sets a port among ports to be assigned to the information processor so as not to receive operation, the port being assigned to a plurality of tracks or a plurality of parameters of signal processing.

20. An audio device comprising:
a communication interface configured to be connected to the information processor according to claim 11;
an input and output interface of an audio signal; and
a controller configured to send information necessary to be displayed on the management screen of the external audio device, through the communication interface.
